(19) United States
(12) Patent Application Publication
(10) Pub. No.: US 2007/0121327 A1
(43) Pub. Date: May 31, 2007

(54) Light-emitting device and process for manufacturing the same

(76) Inventors: Guan-Qun Chen, Taichung Hsien (TW); Chun-Liang Lin, Tainan Hsien (TW); Shu-Kai Hu, Kaohsiung City (TW); Jin-Quan Huang, Kaohsiung Hsien (TW)

Correspondence Address: KNOBBE MARTENS OLSON & BEAR LLP, 2040 MAIN STREET, FOURTEENTH FLOOR, IRVINE, CA, 92614, US

(21) Appl. No.: 11/429,609

(22) Filed: May 5, 2006

(30) Foreign Application Priority Data
Nov. 30, 2005 (TW) 94142169

(51) Int. Cl. F21V 29/00

(52) U.S. Cl. 362/294

(57) ABSTRACT

A light-emitting device and a process for manufacturing the same are described. The light-emitting device comprises: a thin metal layer including a first surface and a second surface on opposite sides; a metal heat sink directly formed and closely connected to the second surface of the thin metal layer; and a light-emitting chip deposed on a portion of the first surface of the thin metal layer, wherein the thin metal layer directly contacts and is closely connected with the light-emitting chip.

### RELATED APPLICATIONS

The present application is based on, and claims priority from, Taiwan Application Serial Number 94142169, filed Nov. 30, 2005, the disclosure of which is hereby incorporated by reference herein in its entirety.

### FIELD OF THE INVENTION

The present invention relates to a light-emitting device and a process for manufacturing the same, and more particularly, to a method for manufacturing a light-emitting device and a heat sink thereof.

### BACKGROUND OF THE INVENTION

When small solid state light-emitting devices, such as light-emitting diodes (LEDs) or laser diodes (LDs), are applied in a large or small backlight module or illumination module, a lot of light-emitting devices are needed for the requirements of brightness or illumination of these modules. However, when the light-emitting devices are operated at high power, the temperature of the module composed of the light-emitting devices increases, degrading the operation quality of the module and ultimately burning out the light-emitting devices.

To resolve this high temperature issue, the module is typically cooled by fans set in the device or by increasing heat dissipation area. However, regarding setting fans in the device, the vibration caused by the operation of the fans results in the lights flickering, and the fans consume additional power. Regarding increasing the heat dissipation area, one or more heat sinks are usually added onto the light-emitting device to do so. Although the heat sinks can be composed of high thermal conductivity metal, glue is needed to connect the light-emitting device to the heat sinks, and the thermal conductivity of the glue is much lower than that of the metal. As a result, the glue acts as a barrier to heat transfer and makes the heat sinks less effective.

Therefore, with the increasing demand for light-emitting devices, such as light-emitting diodes and laser diodes, for backlight modules and illumination modules, a light-emitting device is required having high heat-sinking efficiency.

### SUMMARY OF THE INVENTION

One objective of the present invention is to provide a process for manufacturing a light-emitting device, which directly forms heat-sinking metal on a light-emitting chip by plating deposition, electroless plating deposition or evaporation deposition, so that glue is not necessary for the adhesion of the heat-sinking metal. As a result, the heat-sinking metal is directly connected with the light-emitting chip, which can improve the heat-sinking efficiency of the heat-sinking metal and can effectively enhance the heat-sinking ability of the light-emitting device.

Another objective of the present invention is to provide a process for manufacturing a light-emitting device, which can directly fabricate a metal heat sink on a light-emitting chip by simple process steps, so that the heat conduction area of the light-emitting device is greatly increased to enhance the heat-sinking efficiency of the light-emitting device.

Still another objective of the present invention is to provide a light-emitting device, in which a light-emitting chip is directly connected with a heat-sinking metal, so that the heat generated during the operation of the light-emitting device can be transmitted rapidly, thereby effectively lowering the temperature of the light-emitting device, enhancing the operation quality of the light-emitting device and prolonging the life of the light-emitting device.

According to the aforementioned objectives, the present invention provides a process for manufacturing a light-emitting device, comprising: providing a first adhesive tape, wherein the first adhesive tape includes a first surface and a second surface on opposite sides, and the first surface of the first adhesive tape is adhered to a temporary substrate; providing at least one light-emitting chip, wherein the light-emitting chip includes a first side and a second side opposite to the first side, and the first side of the light-emitting chip is pressed and set into the second surface of the first adhesive tape; providing a second adhesive tape and adhering the second adhesive tape to the second surface of the first adhesive tape, wherein the second adhesive tape comprises at least one hollow pattern to expose the second side of the light-emitting chip and a local region of the second surface of the first adhesive tape adjacent to the second side of the light-emitting chip; forming a thin metal layer on the second side of the light-emitting chip, the local region of the second surface of the first adhesive tape and the second adhesive tape; removing the second adhesive tape to expose a portion of the second surface of the first adhesive tape; forming a metal heat sink on the thin metal layer; and removing the first adhesive tape and the temporary substrate.

According to a preferred embodiment of the present invention, the first surface and the second surface of the first adhesive tape are adhesive, and the first adhesive tape is composed of an acid-proof and alkali-proof material. Furthermore, the step of forming the thin metal layer is performed by an evaporation deposition method, a sputtering deposition method or an electroless plating deposition method, and the step of forming the metal heat sink is performed by a plating method or an electroless plating method.

According to the aforementioned objectives, the present invention further provides a light-emitting device, comprising: a thin metal layer including a first surface and a second surface on opposite sides; a metal heat sink directly formed on the second surface of the thin metal layer; and a light-emitting chip deposed on a portion of the first surface of the thin metal layer, wherein the thin metal layer directly contacts the light-emitting chip.

According to a preferred embodiment of the present invention, a material of the thin metal layer is Ni, Cr, Ti, or an alloy thereof, a thickness of the thin metal layer is less than about 10 μm, and a material of the metal heat sink is Fe/Ni alloy, Cu, Ni, Al, W, or an alloy thereof.

By directly plating the heat-sinking metal onto the light-emitting chip, the heat-sinking metal can contact the light-emitting chip closely, so that heat produced by the light-emitting chip can be directly transmitted to the heat-sinking metal without passing through glue, thereby enhancing the heat-sinking efficiency of the light-emitting device to further increase the operation stability of the light-emitting device.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIGS. 1a through 7 are schematic flow diagrams showing the process for manufacturing a light-emitting device in accordance with a preferred embodiment of the present invention, in which FIGS. 1a, 2a, 3a, 4a, 5a and 6a are top views, and FIGS. 1b, 2b, 3b, 4b, 5b, 6b and 7 are corresponding cross-sectional views.

### DETAILED DESCRIPTION OF THE PREFERRED EMBODIMENT

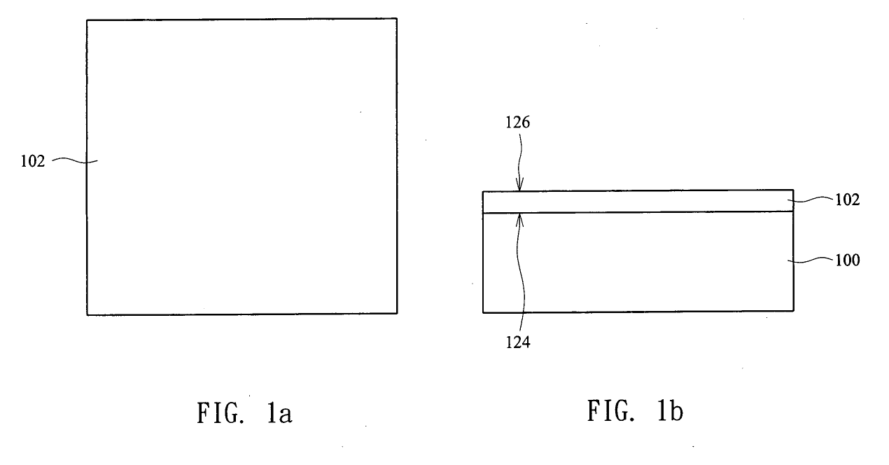

The present invention discloses a light-emitting device and a process for manufacturing the same, in which a metal heat sink is directly fabricated on the light-emitting chip, so that glue is eliminated, the transmitting area and speed of heat can be greatly enhanced, and the light-emitting device effectively and rapidly dissipates heat. In order to make the illustration of the present invention more explicit, the following description is stated with reference to FIGS. 1a through 7.

FIGS. 1a through 7 are schematic flow diagrams showing the process for manufacturing a light-emitting device in accordance with a preferred embodiment of the present invention. In the fabrication of the light-emitting device of the present invention, a temporary substrate 100 and a adhesive tape 102 are firstly provided, wherein the adhesive tape 102 includes two surfaces 124 and 126 on opposite sides, and the surface 124 of the adhesive tape 102 is adhered to a surface of the temporary substrate 100, such as shown in FIGS. 1a and 1b, of which FIG. 1a is the top view and FIG. 1b is the corresponding cross-sectional view. In a preferred embodiment of the present invention, the adhesive tape 102 has a thickness of about 100 μm and is a double-sided adhesive tape, that is, surface 124 and surface 126 are both adhesive. However, in the present invention, if the adhesive tape 102 is composed of a soft plastic material, only the surface 124 might be adhesive while the surface 126 is not adhesive. The adhesive tape 102 is preferably composed of an acid-proof and alkali-proof material.

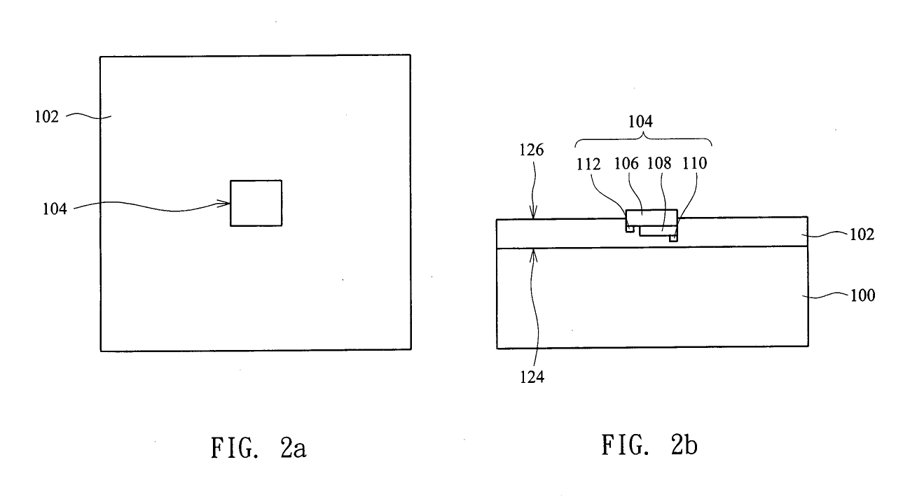

Then, one or more light-emitting chips 104 are provided, wherein the light-emitting chips 104 are, for example, light-emitting diode chips or laser diode chips. Each light-emitting chip 104 may include a growth substrate 106, an illuminant structure 108, and two electrodes 110 and 112 of different conductivity types, wherein the illuminant structure 108 is deposed on the substrate 106, the electrode 110 may be P-type, and the electrode 112 may be N-type. In the present embodiment, the electrodes 110 and 112 of the light-emitting chip 104 are deposed at the same side of the growth substrate 106. However, the electrodes of different conductivity types may be respectively deposed at different sides of the growth substrate of the light-emitting chip in the present invention. A side of the light-emitting chip 104 is pressed downward on the surface 126 of the adhesive tape 102 to make the light-emitting chip 104 adhere to or embed into the surface 126 of the adhesive tape 102 and to expose the side of the light-emitting chip 104 opposite to the adhered side, such as shown in FIGS. 2a and 2b, wherein FIG. 2a is the top view and FIG. 2b is the corresponding cross-sectional view. In the present invention, when many light-emitting chips 104 are set simultaneously, they can be arranged according to the process requirements.

The light-emitting chips 104 may be GaN-based light-emitting diodes, AlGaInP-based light-emitting diodes, PbS-based light-emitting diodes or SiC-based light-emitting diodes. In another embodiment, the light-emitting chips 104 may be GaN-based laser diodes, AlGaInP-based laser diodes, PbS-based laser diodes or SiC-based laser diodes.

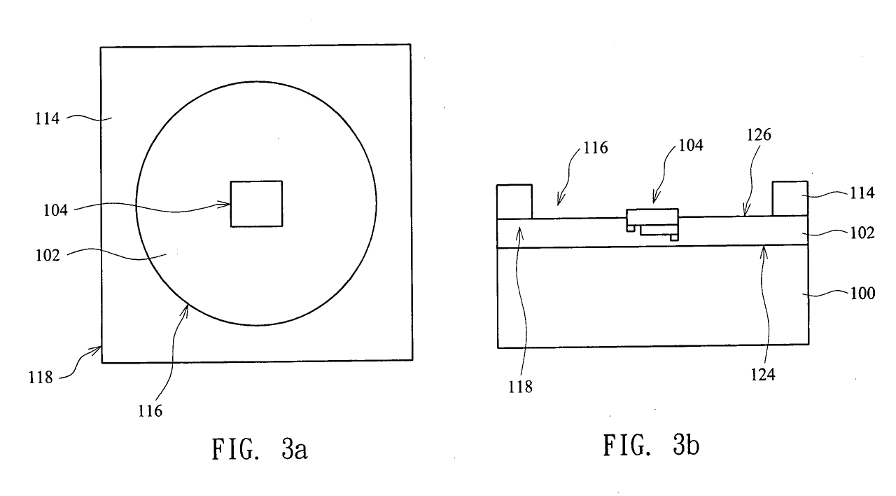

After the light-emitting chip 104 is fixed in the adhesive tape 102, another adhesive tape 114 is adhered to the surface 126 of the adhesive tape 102, wherein the adhesive tape 114 is single-sided adhesive or double-sided adhesive. The adhesive tape 114 comprises a hollow pattern corresponding to the location of the light-emitting chip 104, so that the adhesive tape 114 is only deposed on a region 118 of the surface 126 of the adhesive tape 102 to expose the unburied side of the light-emitting chip 104 and a local region 116 of the surface 126 of the adhesive tape 102 adjacent to the unburied side of the light-emitting chip 104, such as shown in FIGS. 3a and 3b, in which FIG. 3a is the top view and FIG. 3b is the corresponding cross-sectional view.

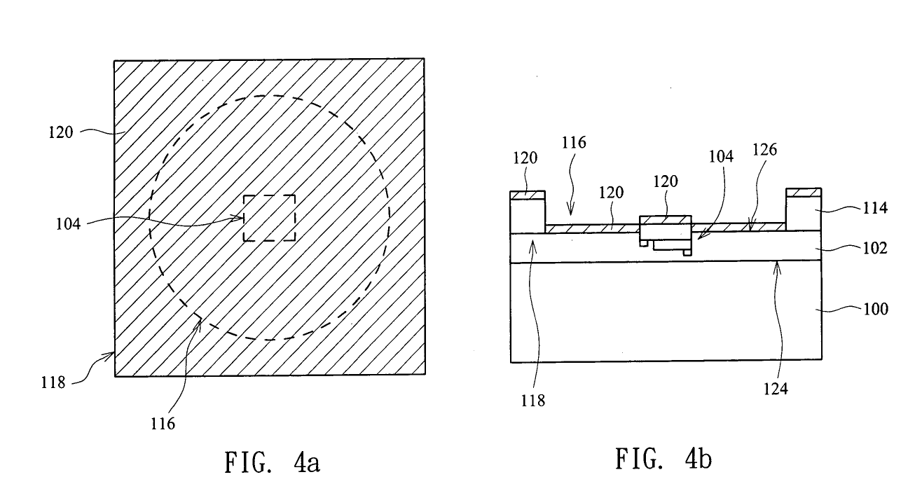

Next, a thin metal layer 120 is formed to cover the exposed surface of the light-emitting chip 104, the region 116 in the surface 126 of the adhesive tape 102, and the adhesive tape 114 by, for example, an evaporation deposition method, a sputtering deposition method or an electroless plating deposition method, such as shown in FIGS. 4a and 4b, in which FIG. 4a is the top view and FIG. 4b is the corresponding cross-sectional view. The thin metal layer 120 is preferably composed of a metal material of good adhesion, such as Ni, Cr, Ti, or an alloy thereof, to facilitate the deposition of the metal material. In the present invention, a thickness of the thin metal layer 120 is preferably less than about 10 μm.

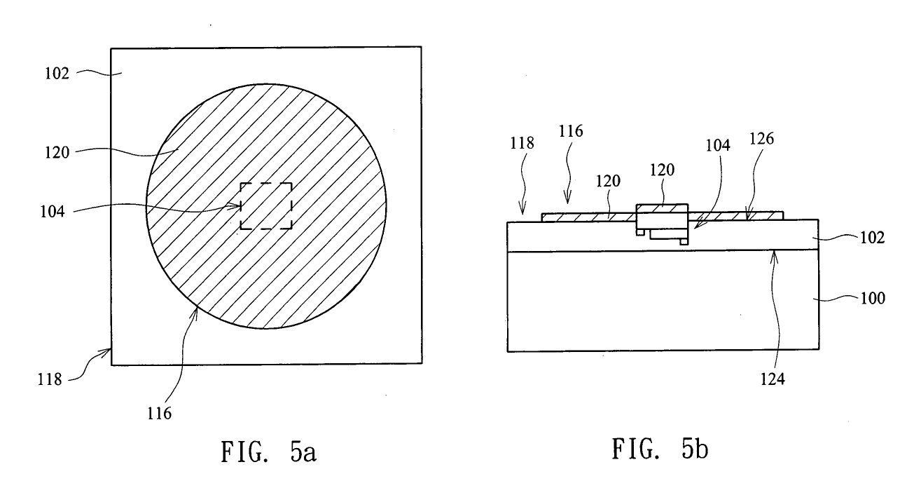

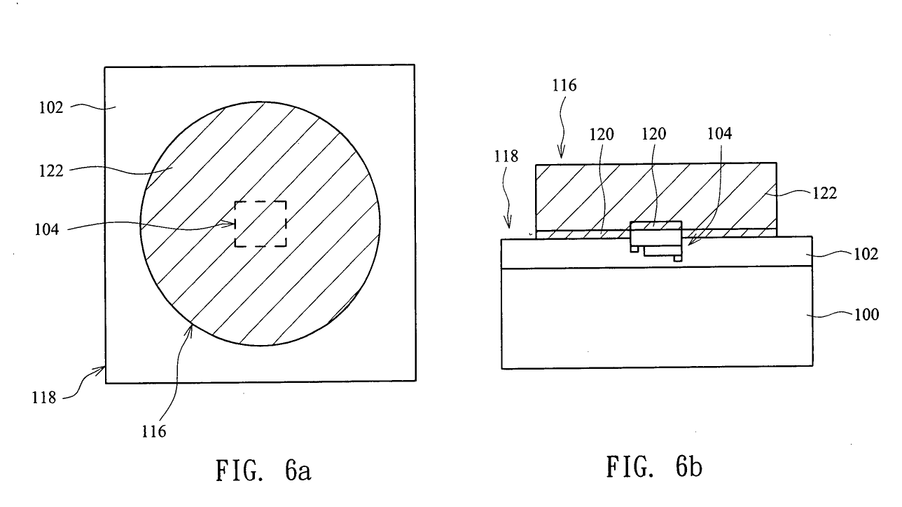

After the thin metal layer 120 is formed, the adhesive tape 114 is removed to expose the region 118 in the surface 126 of the adhesive tape 102, so as to form the structure shown in FIG. 5b. When the adhesive tape 114 is removed, the thin metal layer 120 located on the adhesive tape 114 is removed simultaneously, such as shown in FIG. 5a. Then, a thicker metal layer is formed on the thin metal layer 120 by, for example, a plating method or an electroless plating method and is used as a metal heat sink 122. Because the metal heat sink 122 is formed by a plating method or an electroless plating method in the present invention, the metal heat sink 122 is substantially grown on the thin metal layer 120, such as shown in FIGS. 6a and 6b, in which FIG. 6a is the top view and FIG. 6b is the corresponding cross-sectional view. In the present invention, the metal heat sink 122 is preferred composed of a metal of good thermal conductivity, such as Fe/Ni alloy, Cu, Ni, Al, W, or an alloy thereof. The metal heat sink 122 is generally thicker and preferably has a thickness greater than about 50 μm for larger heat conduction.

One feature of the present invention is that the thin metal layer is firstly formed by an evaporation deposition method, a sputtering deposition method or an electroless plating deposition method and is used as the base for plating or electroless plating the metal heat sink, wherein an adhesive tape is further used to define the pattern of the thin metal layer in the fabrication of the thin metal layer. As a result, the present process is very simple, and the standard process equipment can still be used, thereby preventing increasing the process cost. Furthermore, in the present invention, the heat-sinking metal can be directly fabricated on the surface of the light-emitting chip to make the heat-sinking metal closely contact the surface of the light-emitting chip, greatly increasing the heat-transmitting area and the heat-transmitting speed of the light-emitting device.

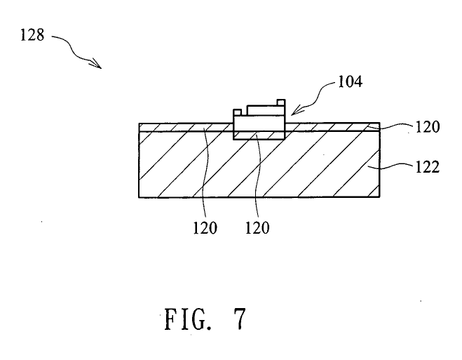

After the metal heat sink 122 is formed, the adhesive tape 102 and the temporary substrate 100 are removed to complete the fabrication of the light-emitting device 128, such as shown in FIG. 7. Because the thin metal layer 120 and the light-emitting chip 104 adhere to the temporary substrate 100 by the adhesive tape 102, the metal heat sink 122, the thin metal layer 120 and the light-emitting chip 104 can be separated from the temporary substrate 100 easily.

According to the aforementioned description, one advantage of the present invention is that the process for manufacturing the light-emitting device directly forms heat-sinking metal on a light-emitting chip by plating deposition, electroless plating deposition or evaporation deposition, so that the heat-sinking metal is closely connected with the light-emitting chip without glue. Therefore, the heat-sinking metal can improve the heat-sinking efficiency and the heat-sinking ability of the light-emitting device.

According to the aforementioned description, another advantage of the present invention is that the process for manufacturing the light-emitting device can directly fabricate a metal heat sink on a light-emitting chip by simple process steps with standard equipment, so that the process yield is enhanced and the heat conduction area of the light-emitting device is increased, thereby enhancing the heat-sinking efficiency of the light-emitting device.

According to the aforementioned description, still another advantage of the present invention is that the light-emitting chip is directly connected with a heat-sinking metal, so that the heat generating during the operation of the light-emitting device can be transmitted rapidly, thereby effectively lowering the temperature of the light-emitting device, enhancing the operation quality of the light-emitting device, improving the operation stability of the light-emitting device and prolonging the life of the light-emitting device.

As is understood by a person skilled in the art, the foregoing preferred embodiments of the present invention are illustrated of the present invention rather than limiting of the present invention. It is intended that various modifications and similar arrangements included within the spirit and scope of the appended claims be covered, the scope of which should be accorded the broadest interpretation so as to encompass all such modifications and similar structure.

What is claimed is:

1. A process for manufacturing a light-emitting device, comprising:
providing a first adhesive tape, wherein the first adhesive tape includes a first surface and a second surface on opposite sides, and the first surface of the first adhesive tape is adhered to a temporary substrate;
providing at least one light-emitting chip, wherein the at least one light-emitting chip includes a first side and a second side opposite to the first side, and the first side of the at least one light-emitting chip is pressed and set into the second surface of the first adhesive tape;
providing a second adhesive tape and adhering the second adhesive tape to the second surface of the first adhesive tape, wherein the second adhesive tape comprises at least one hollow pattern to expose the second side of the at least one light-emitting chip and a local region of the second surface of the first adhesive tape adjacent to the second side of the at least one light-emitting chip;
forming a thin metal layer on the second side of the at least one light-emitting chip, the local region of the second surface of the first adhesive tape, and the second adhesive tape;
removing the second adhesive tape to expose a portion of the second surface of the first adhesive tape;
forming a metal heat sink on the thin metal layer; and
removing the first adhesive tape and the temporary substrate.

2. The process for manufacturing a light-emitting device according to claim 1, wherein the first surface and the second surface of the first adhesive tape are adhesive.

3. The process for manufacturing a light-emitting device according to claim 1, wherein the first adhesive tape is composed of an acid-proof and alkali-proof material.

4. The process for manufacturing a light-emitting device according to claim 1, wherein the at least one light-emitting chip includes at least one light-emitting diode chip or at least one laser diode chip.

5. The process for manufacturing a light-emitting device according to claim 4, wherein the at least one light-emitting chip is selected from the group consisting of GaN-based light-emitting chips, AlGaInP-based light-emitting chips, PbS-based light-emitting chips and SiC-based light-emitting chips.

6. The process for manufacturing a light-emitting device according to claim 4, wherein the at least one light-emitting chip includes two electrodes with different conductivity types, and the electrodes are deposed at the same side of a growth substrate of the at least one light-emitting chip.

7. The process for manufacturing a light-emitting device according to claim 4, wherein the at least one light-emitting chip includes two electrodes with different conductivity types, and the electrodes are deposed at different sides of a growth substrate of the at least one light-emitting chip.

8. The process for manufacturing a light-emitting device according to claim 1, wherein the thin metal layer is composed of an adhesive metal material.

9. The process for manufacturing a light-emitting device according to claim 1, wherein a material of the thin metal layer is Ni, Cr, Ti, or an alloy thereof.

10. The process for manufacturing a light-emitting device according to claim 1, wherein a thickness of the thin metal layer is less than about 10 μm.

11. The process for manufacturing a light-emitting device according to claim 1, wherein the step of forming the thin metal layer is performed by an evaporation deposition method, a sputtering deposition method or an electroless plating deposition method.

12. The process for manufacturing a light-emitting device according to claim 1, wherein the metal heat sink is composed of a metal, and the metal is Fe/Ni alloy, Cu, Ni, Al, W or an alloy thereof.

13. The process for manufacturing a light-emitting device according to claim 1, wherein a thickness of the metal heat sink is greater than about 50 μm.

14. The process for manufacturing a light-emitting device according to claim 1, wherein the step of forming the metal heat sink is performed by a plating method or an electroless plating method.

15. A light-emitting device, comprising:
a thin metal layer including a first surface and a second surface on opposite sides;
a metal heat sink directly formed and closely connected to the second surface of the thin metal layer; and
a light-emitting chip deposed on a portion of the first surface of the thin metal layer, wherein the thin metal layer directly contacts and is closely connected with the light-emitting chip.

16. The light-emitting device according to claim 15, wherein the light-emitting chip is a light-emitting diode chip or a laser diode chip.

17. The light-emitting device according to claim 16, wherein the light-emitting chip is selected from the group consisting of a GaN-based light-emitting chip, an AlGaInP-based light-emitting chip, a PbS-based light-emitting chip and a SiC-based light-emitting chip.

18. The light-emitting device according to claim 16, wherein the light-emitting chip includes two electrodes with different conductivity types, and the electrodes are deposed at the same side of a growth substrate of the light-emitting chip.

19. The light-emitting device according to claim 16, wherein the light-emitting chip includes two electrodes with different conductivity types, and the electrodes are deposed at different sides of a growth substrate of the light-emitting chip.

20. The light-emitting device according to claim 15, wherein the thin metal layer is composed of an adhesive metal material.

21. The light-emitting device according to claim 15, wherein a material of the thin metal layer is Ni, Cr, Ti, or an alloy thereof.

22. The light-emitting device according to claim 15, wherein a thickness of the thin metal layer is less than about 10 μm.

23. The light-emitting device according to claim 15, wherein the metal heat sink is composed of Fe/Ni alloy, Cu, Ni, Al, W or an alloy thereof.

24. The light-emitting device according to claim 15, wherein a thickness of the metal heat sink is greater than about 50 μm.

25. The light-emitting device according to claim 15, wherein the metal heat sink is composed of a plated metal layer or an electroless plated metal layer.
